(19) United States
(12) Patent Application Publication
(10) Pub. No.: US 2015/0160738 A1
(43) Pub. Date: Jun. 11, 2015

(54) KEYBOARD PROJECTION SYSTEM WITH IMAGE SUBTRACTION

(71) Applicants: David S. Lithwick, Thornhill (CA); Clifford M. Rhee, Mississauga (CA)

(72) Inventors: David S. Lithwick, Thornhill (CA); Clifford M. Rhee, Mississauga (CA)

(21) Appl. No.: 14/627,294

(22) Filed: Feb. 20, 2015

Related U.S. Application Data
(63) Continuation of application No. PCT/CA2013/050642, filed on Aug. 20, 2013.
(60) Provisional application No. 61/691,030, filed on Aug. 20, 2012.
(60) Provisional application No. 61/713,192, filed on Oct. 12, 2012.
(60) Provisional application No. 61/733,237, filed on Dec. 4, 2012.

(51) Int. Cl. G06F 3/02

(52) U.S. Cl. CPC G06F 3/0202

(57) ABSTRACT

A method for detecting a keystroke operated on a projected keyboard, and an associated device are disclosed. A first image and a second image of the projected keyboard are captured. Preferably, while the first image is taken, an infrared (IR) beam is projected on the keyboard, and while the second image is taken, the IR beam is switched off. The second image is subtracted from the first image to remove noise and detect a difference between the first and second image. The location where the difference is detected is associated with the keystroke. The location of the keystroke is determined in relation to the projected image of the keyboard. The location is then associated with a key of the keyboard based on a keyboard layout stored in a memory. A command signal corresponding to the key is then generated for transmittal to the computing device.

### FIELD OF THE INVENTION

The present invention relates to a keyboard projection system and method. The present also relates to a calibration system and method for the keyboard projection system.

### BACKGROUND OF THE INVENTION

Standard keyboards are generally provided by a device having an arrangement of keys, which can be pressed on to allow a user to enter input information into a computer or the like. A keyboard may be provided by a standalone device or it may be made as part of the computer, such as in the case of some laptop (or “notebook”) computers, personal digital assistants (PDA) and smartphones.

Also known in the art are virtual keyboards provided on a touch screen, where a graphical image of a keyboard appears on the touch screen which then detects a touching action on the screen and its location in order to associate the action with one of the keys of the keyboard. Such keyboards are generally useful for portability and travel, for devices such as tablet computers, smartphones, PDAs, etc. in order to optimize screen size and eliminate the need for providing a physical keyboard. However, although such a keyboard solution is compact and portable, the portion of the display screen which is used by the keyboard when it is displayed, takes away from the displaying area of the screen.

Furthermore, virtual keyboards are also known to be projected on a surface. However, such conventional systems generally require a bulky projection device and therefore do not provide for convenience of portability for the user.

Furthermore, conventional laser projection devices require the absolute precise alignment of the camera, laser projection and IR beam in order to properly factory calibrate the device in a stored and fixed array structure at assembly time not allowing for any movement and causing many failures after the customer receipt of said product.

Furthermore, projection devices known to the Applicant are limited to show the user's keystrokes on an external device connected to the projection device via Bluetooth™ or via a Universal Serial Bus (USB) connector, preventing the user from receiving visible feedback directly from the projection device.

Such projection devices require the user to select the Bluetooth™ mode manually by moving a switch to SPP (serial port protocol) or HID (human interface device) for the proper communication protocol for each external host device the laser keyboard projection device is to connect with.

Known devices must use a revised keyboard layout to accommodate the limited field of view of the camera sensor and infrared transmitter. Users have gotten used to the Qwerty keyboard layout such that a much larger field of view had to be developed to allow for a full size keyboard layout.

Furthermore, automated calibration algorithms would need to be addressed in such devices to allow for camera distortion as it is currently impossible to have a 100 degree or more field of view camera without distortion in the lens size needed. Each unit would require its own calibration as it would have a different level of distortion and rotation factors depending where the keyboard layout landed in relation to the camera lens.

Current virtual keyboards do not have wide enough IR transmitters as the current lens only reaches 90 degrees of transmission.

Known virtual laser keyboard systems are often bulky, consume a lot of power and are cost prohibitive. There is thus a need for an improved system made from more cost effective components and using technology with a much smaller footprint.

In addition, current devices are limited by lighting conditions as they use a constant IR pulse making it extremely difficult to block out extraneous infrared sources such as sunlight and UV lighting and other IR emitting devices that cause many false activations.

Users that have dark painted nails have a very low activation level and previous devices have been unable to detect the finger activation in such cases. There is thus a need for an improved keyboard projection system allowing the detection of all colors of painted nails.

Known to the Applicant are U.S. Pat. No. 6,614,422 dated Sep. 2, 2003 (RAFII et al.), U.S. Pat. No. 6,710,770 dated Mar. 23, 2004 (TOMASI et al.), and U.S. Pat. No. 7,151,530 B2 dated Dec. 19, 2006 (ROEBER et al.).

Hence, in light of the aforementioned, there is a need for an improved system which, by virtue of its design and components, would be able to overcome some of the above-discussed prior art concerns.

### SUMMARY OF THE INVENTION

The object of the present invention is to provide a device which, by virtue of its design and components, satisfies some of the above-mentioned needs and is thus an improvement over other related keyboards known in the prior art.

In accordance with the present invention, the above mentioned object is achieved, as will be easily understood, by a projected keyboard system such as the one briefly described herein and such as the one exemplified in the accompanying drawings.

In accordance with an aspect of the present, there is provide a method for detecting a keystroke operated on an image of a keyboard projected on a surface, to be processed by a computing device, a layout of the keyboard being stored in a memory, the method comprising the steps of
a) sensing, by means of a sensing module, a keystroke in the projected image, said sensing comprising:
   (i) capturing a first image of the projected image, by means of a sensor;
   (ii) capturing a second image of the projected image, by means of the sensor; and
   (iii) subtracting, by means of a processor, the second image from the first image to detect a difference between the first and second image and to associate said difference with the keystroke;
b) determining, by means of the processor, a location of said keystroke with respect to the projected image;
c) associating, by means of the processor, said location with a key of the keyboard based on the layout stored in the memory; and
d) generating a command signal corresponding to the key, for transmittal of the command signal to the computing device.

According to a particular embodiment, the capturing of step (a)(i) further comprises emitting a beam, preferably an infrared (IR) beam, across the projected image by means of an emitter during said capturing of the first image, and switching off said beam for the capturing of step (a)(ii).

In accordance with another aspect of the present, there is provide a keyboard projection device for a computing device, comprising:
a memory for storing a layout of a keyboard;
a projector connected to the memory, for projecting an image of the keyboard on a surface;
a sensing module comprising a sensor for capturing a first image of the projected image and for capturing a second image of the projected image;
a processor connected to the sensor module, for subtracting the second image from the first image to detect a difference between the first and second image to the keystroke, for associating said difference with a keystroke, for determining a location of said keystroke with respect to the projected image, and for associating said location with a key of the keyboard layout stored in the memory; and
an output port connected to the processor, for transmitting to the computing device, a command signal corresponding to the associated key.

In accordance with another aspect of the present, there is provide a storage medium comprising data and instructions for execution by a processor for detecting a keystroke operated on an image of a keyboard projected on a surface from first and second images of the projected image of the keyboard, for the keystroke to be processed by a computing device, said data and instructions comprising:
code means for subtracting the second image from the first image to detect a difference between the first and second image and to associate said difference to the keystroke;
code means for determining a location of said keystroke with respect to the projected image;
code means for associating said location with a key of the keyboard layout stored in the memory; and
code means for generating a command signal corresponding to the key, for transmittal to the computing device.

The objects, advantages and features of the present invention will become more apparent upon reading of the following non-restrictive description of preferred embodiments thereof, given for the purpose of exemplification only, with reference to the accompanying drawings.

### BRIEF DESCRIPTION OF THE DRAWINGS

FIG. 1A shows a device projecting a keyboard on a surface, in accordance with an embodiment of the present invention, the device being shown with a smartphone connected thereto.

FIG. 1B shows a device projecting a keyboard on a surface, in accordance with a second embodiment of the present invention, the device being shown with a smartphone connected thereto via Bluetooth™’

FIG. 2 shows hardware components of a device for projecting a keyboard on a surface, in accordance with the embodiment shown in FIG. 1B.

FIG. 3 shows two (2) devices for projecting a keyboard, in accordance with the embodiment shown in FIG. 1B.

FIG. 4A-4F are various views of the device for projecting a keyboard, in accordance with the embodiment shown in FIG. 1A, wherein FIG. 4A is a front plan view of the device being shown with a connector configured in an extended configuration, FIG. 4B is a plan front view of the device being shown with a connector configured in a retracted configuration, FIG. 4C is a right side plan view of the device, FIG. 4D is a rear plan view of the device, FIG. 4E is a left side plan view of the device, and FIG. 4F is a top plan view of the device.

FIG. 5A and FIG. 5B show perspective views of one of the devices shown in FIG. 3, the device being shown with a key chain attached thereto.

FIG. 6 illustrates a keyboard projection, projected by a device in accordance with an embodiment of the present invention.

FIG. 7 is a diagram illustrating steps of a method carried out, in accordance with an embodiment of the present invention.

FIG. 8 is a flow chart representing the steps of the method, in accordance with the embodiment shown in FIG. 7.

FIG. 9A is a schematic diagram showing a projection of a keyboard with dimensions of the device, in accordance with an embodiment of the present invention.

FIG. 9B is a schematic diagram of the projection shown in FIG. 9A, the projection being shown from at top plan view showing projection angles of the embodiment.

FIG. 9C is a schematic diagram of the projection shown in FIG. 9A, the projection being shown from at side plan view showing projection angles of the embodiment.

FIG. 10A-10E are various views of the device for projecting a keyboard, in accordance with the embodiment shown in FIG. 1B, wherein FIG. 10A is a front plan view of the device, FIG. 10B is a right side plan view of the device, FIG. 10C is a rear plan view of the device, FIG. 10D is a left side plan view of the device, and FIG. 10E is a top plan view of the device.

FIG. 11A to 11D show a map of a projected keyboard viewed by a camera of a keyboard projection device, in accordance with an embodiment of the present invention, wherein FIG. 11A shows the outlining border of the map and rows of keys, as viewed by the camera; FIG. 11B shows the map shown in FIG. 11A, further illustrating calibration points; FIG. 11C shows the map shown in FIG. 11B, further illustrating an identified keystroke being associated to a key having boundaries in a reference mapping; FIG. 11D shows the map shown in FIG. 11C, further illustrating a rotational shift of the boundary of the concerned key, with respect to the boundary set by the factory setting.

FIG. 12A show steps for operating a device for projecting a keyboard, in accordance with an embodiment of the present invention, to calibrate the device.

FIG. 12B show specifications of a projector of the device of FIG. 12A.

FIG. 12C show specifications of a sensor of the device of FIG. 12A.

FIG. 13A shows a keyboard projected by a device for projecting a keyboard, in accordance with an embodiment of the present invention.

FIG. 13B shows an image of the projected keyboard shown in FIG. 13A, as sensed by a sensor of the device for projecting a keyboard, the image being referenced horizontally along x coordinates, the image being further referenced vertically along y coordinates.

FIG. 13C is a graph of the intensity of the image of FIG. 13B, for each x coordinate.

FIG. 13D is a graph of the intensity of the image of FIG. 13B, for each y coordinate.

FIG. 13E is a histogram of sample of light intensity having been captured by the device for projecting a keyboard, in accordance with an embodiment of the present invention.

FIG. 14A is a front plan view of a device for projecting a keyboard, in accordance with a third embodiment.

FIG. 14B is a side plan view of the device shown in FIG. 14A.

FIG. 15 is a photograph of a device for projecting a keyboard, in accordance with the third embodiment, the device being shown from a front plan view.

FIG. 16A is another photograph of a device for projecting a keyboard, in accordance with the third embodiment, the device being shown from a front plan view.

FIG. 16B is a photograph of the device shown in FIG. 16A, the device being shown from a rear plan view.

FIG. 16C is a photograph of the device shown in FIG. 16A, the device being shown from a side plan view.

FIG. 17A is a front perspective view of a device for projecting a keyboard, in accordance with the third embodiment, the device being shown partially, components of the device having been omitted.

FIG. 17B is another front perspective view of the device shown in FIG. 17A, the device being shown with additional components of the device having been omitted.

FIG. 17C is another front perspective view of the device shown in FIG. 17B, the device being shown with additional components of the device having been omitted.

FIG. 17D is a side perspective view of the device shown in FIG. 17A, the device being shown with a component drawn in phantom lines.

FIG. 17E is a top perspective view of the device shown in FIG. 17C.

FIG. 17F is a bottom perspective view of the device shown in FIG. 17C.

FIG. 18 show steps for operating a device for projecting a keyboard, in accordance with an embodiment of the present invention, between a keyboard mode and a mouse mode.

### DETAILED DESCRIPTION OF PREFERRED EMBODIMENTS OF THE INVENTION

In the following description, the same numerical references refer to similar elements. The embodiments mentioned and/or geometrical configurations and dimensions shown in the figures or described in the present description are embodiments of the present invention only, given for exemplification purposes only.

Broadly described, the projection device according to a preferred embodiment of the present invention, as exemplified in the accompanying drawings, is a peripheral device for a computer or the like which projects a laser (or other light) in the shape of a keyboard on a given surface, and captures a user action on the surface where the keyboard is projected, in order to recognize a keystroke.

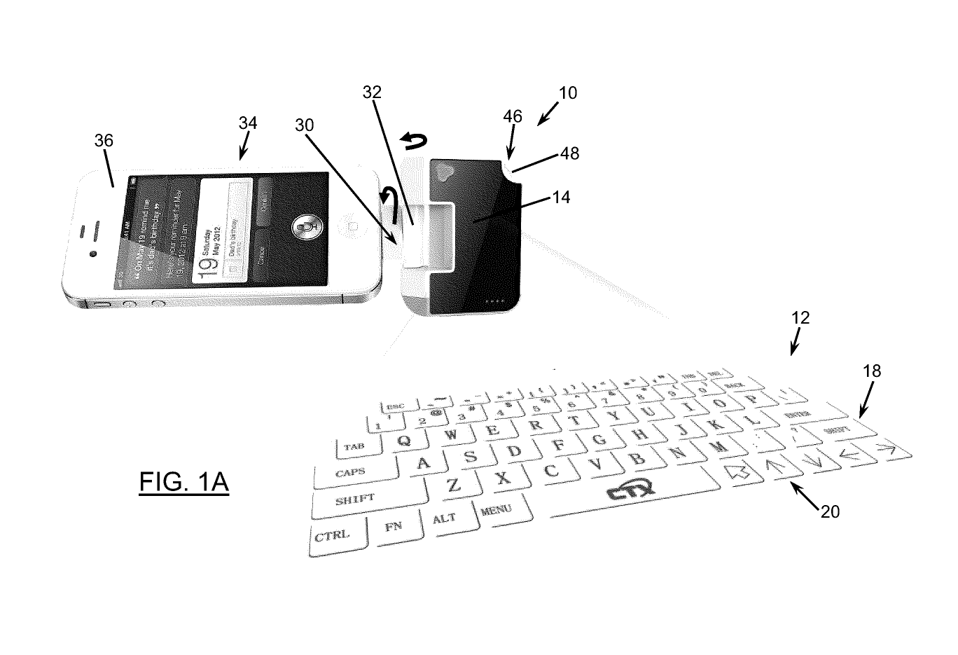

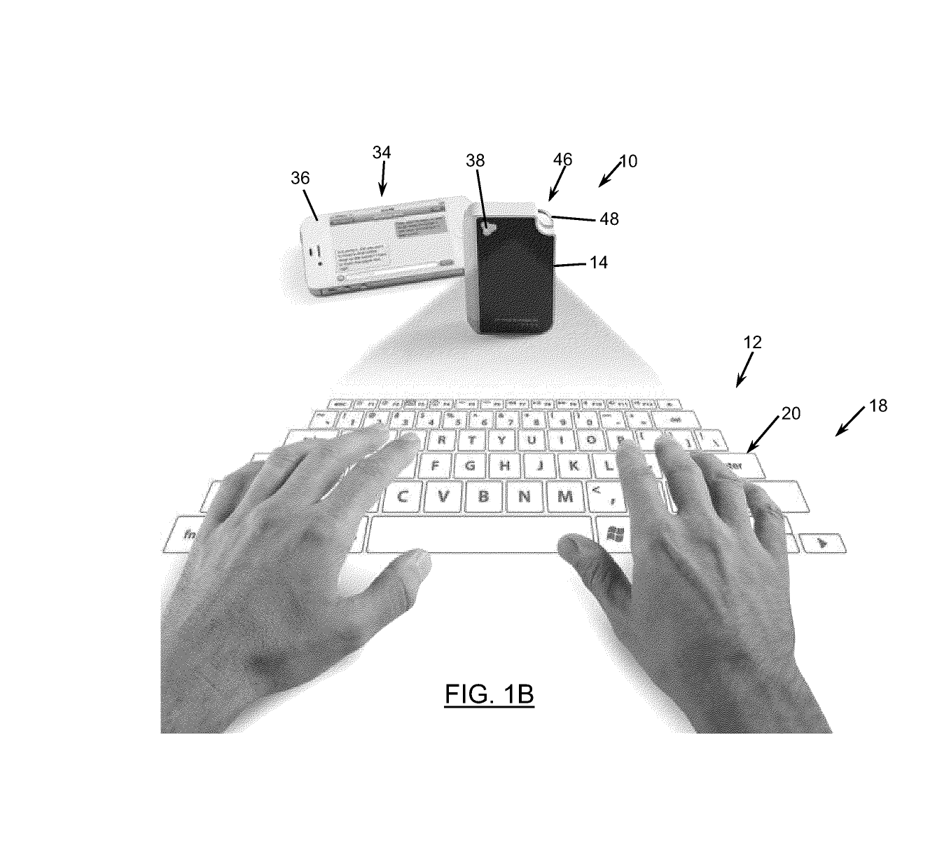

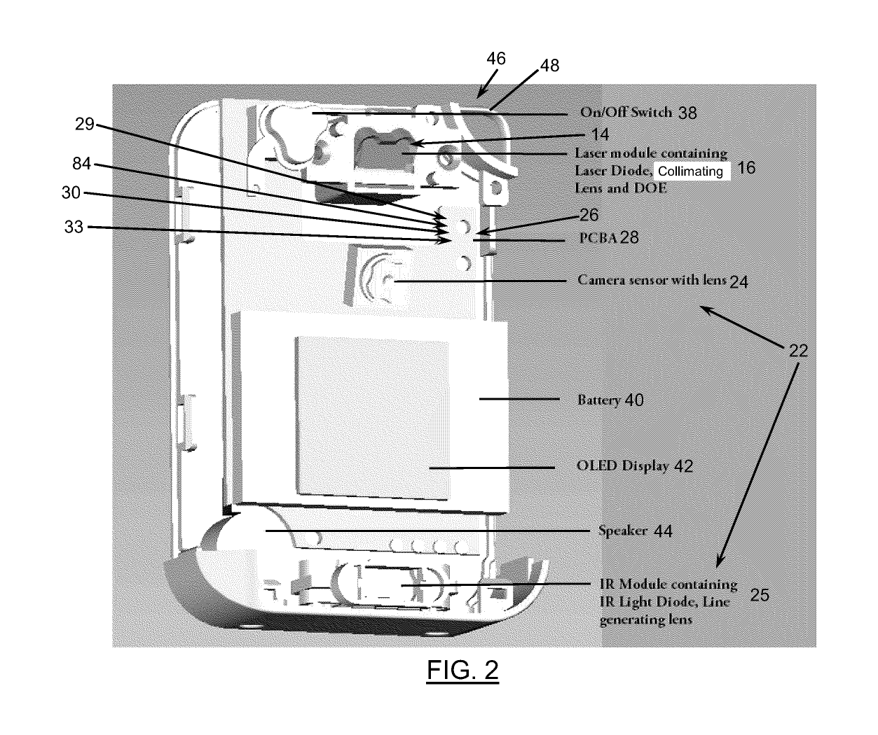

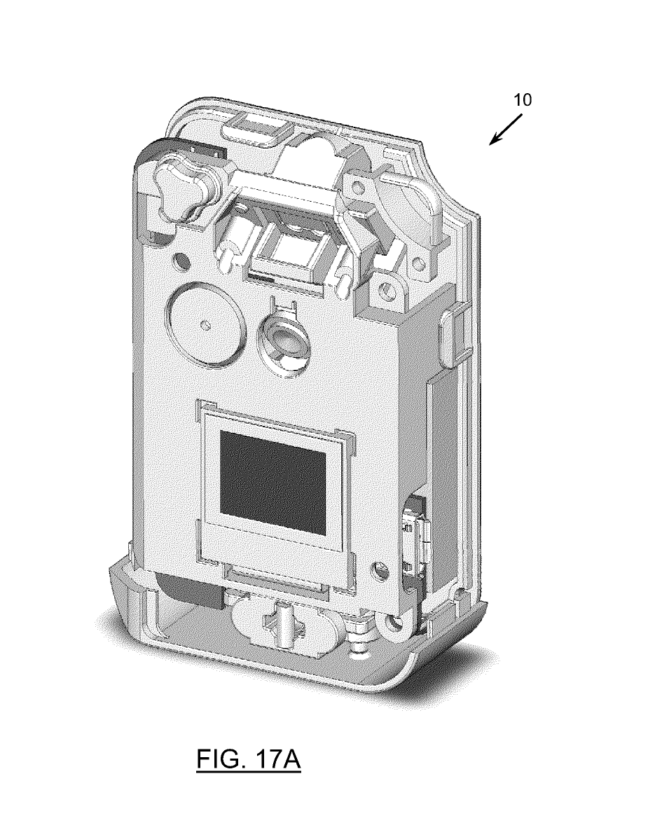

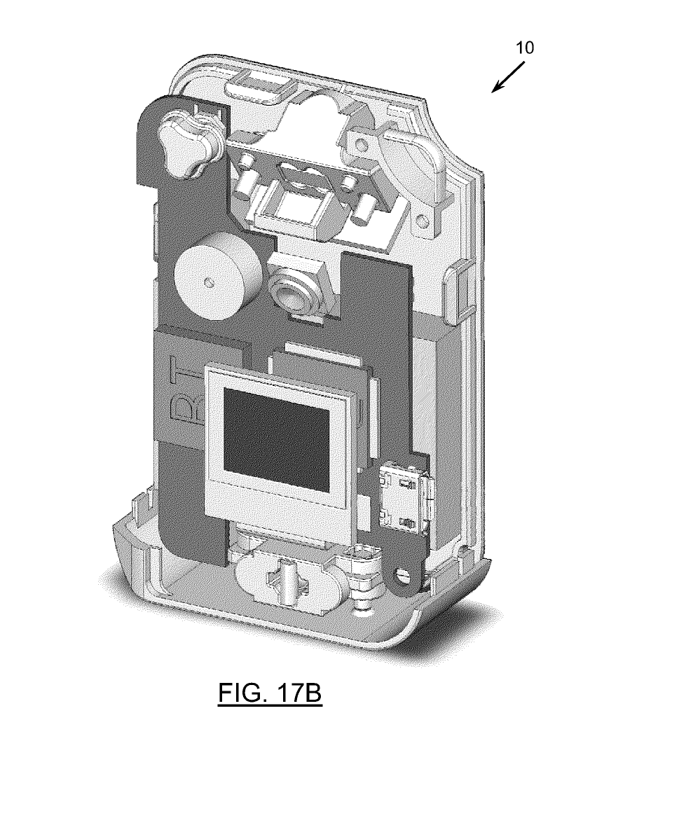

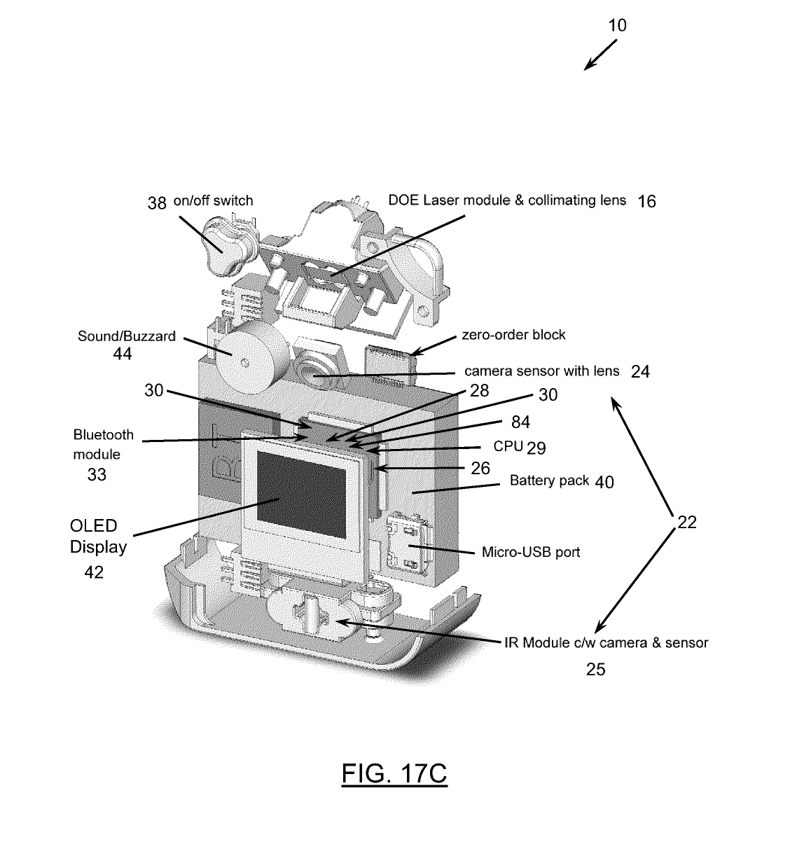

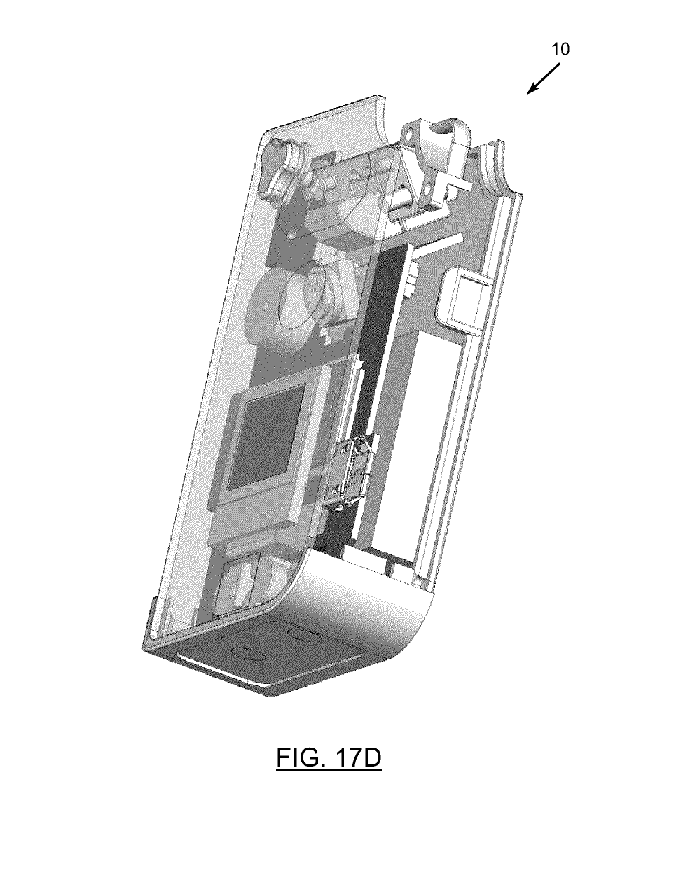

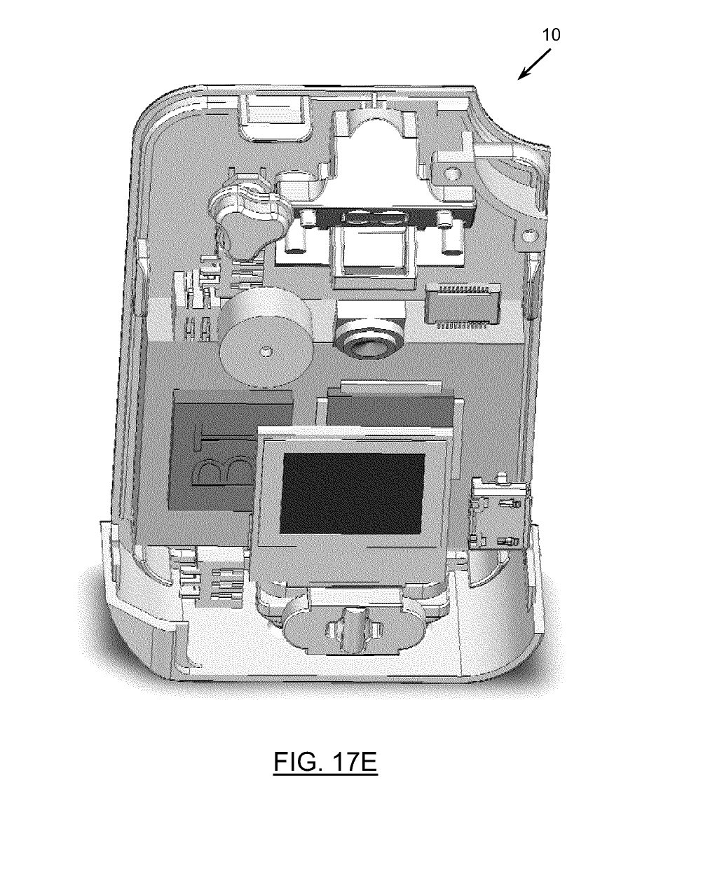

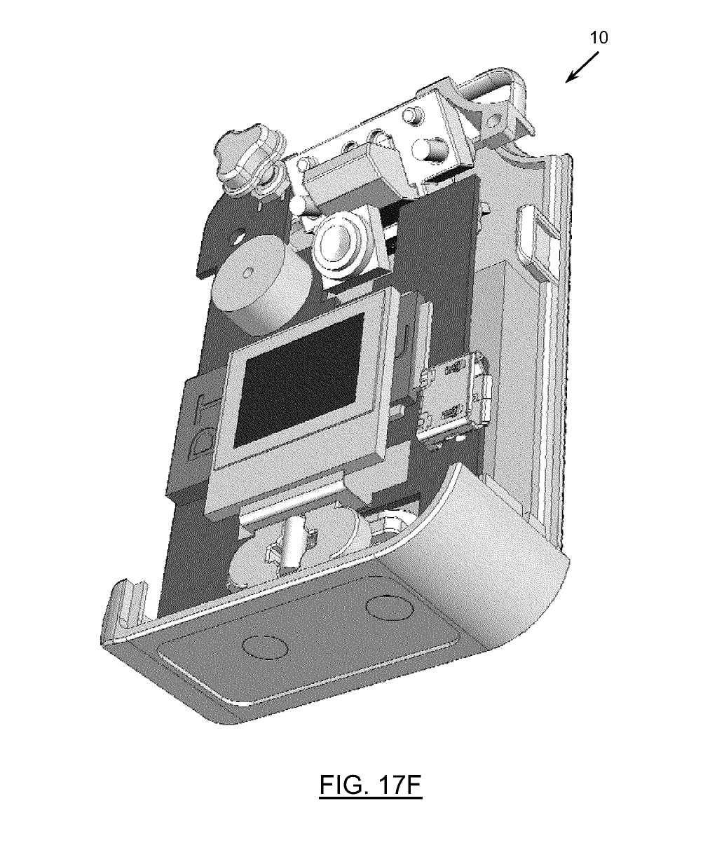

Preferably, as better illustrated in FIG. 1A (first embodiment), in FIGS. 1B and 2 (second embodiment), and in FIG. 17C (third embodiment), there is provided a peripheral device 10 for projecting a keyboard on a given surface 12, the device comprising:
a) a pattern projector module 14, such as a laser module 16, for projecting an image 18 of a keyboard 20 on said surface 12;
b) a sensor assembly 22, comprising a camera 24 and infrared (IR) module 25, for sensing an interruption in the projected image 18;
c) a calculator 26, for example integrated in a CPU 29 which is embedded in a printed circuit board assembly (PCBA) 28, the CPU 29 comprising a memory 84, the calculator 26 being in communication with the light emitter 14 and the sensor module 22 for determining a location of said interruption with respect to the projected image 18 and associating said interruption with a keystroke of the keyboard 20, in order to produce corresponding input data;
d) communication means 30 being in communication with the calculator 26 and adapted to transmit the input data to a computing device 34, such as to a smartphone 36.

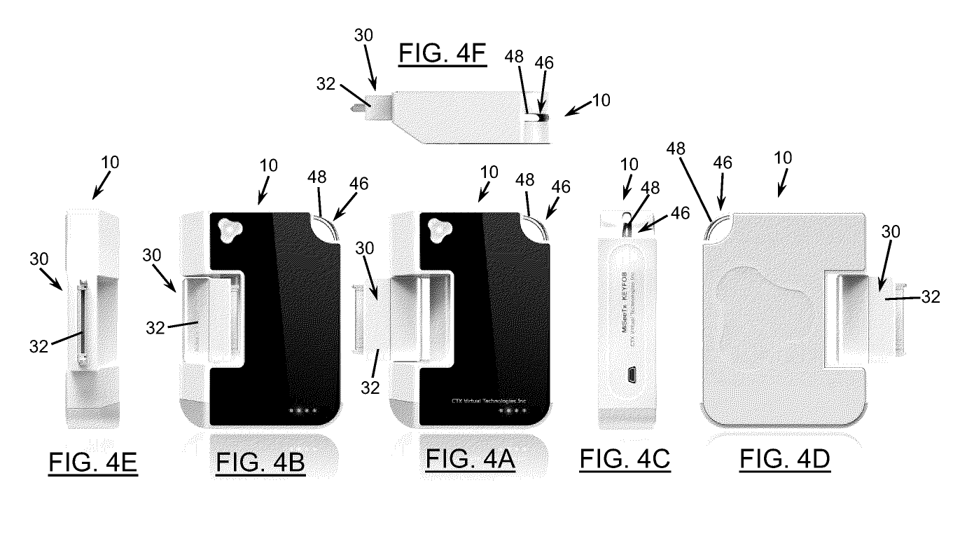

FIGS. 1A and 4 show the device 10, according to a first embodiment of the present invention, where the communication means 30 is provided by a hard-wire connector 32. The connector 32 is pivotally mounted on the device 10 with friction grip so as to further support the smartphone 36 and allow an angular adjustment thereof.

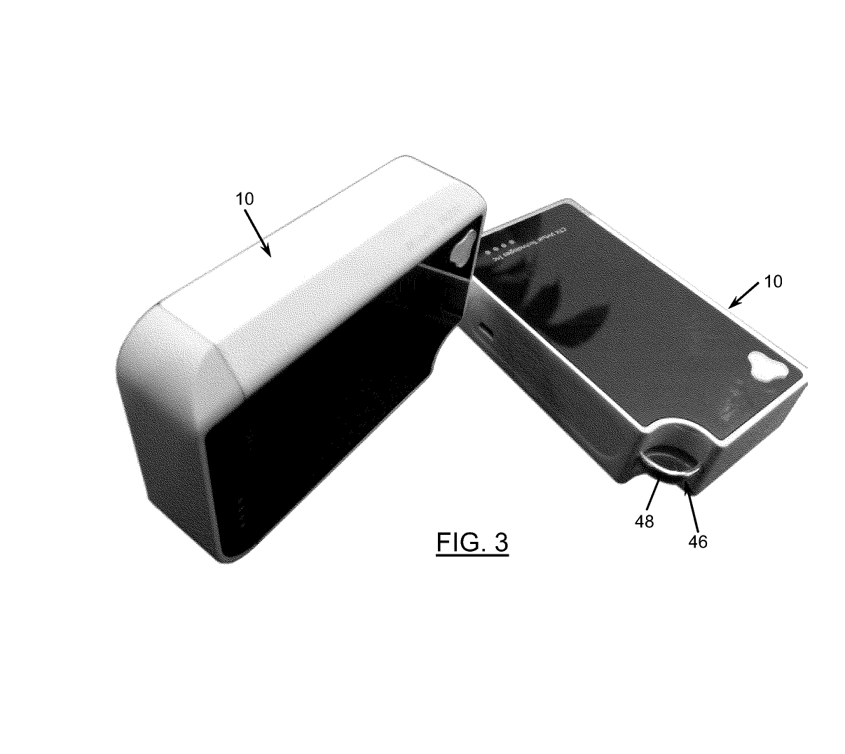

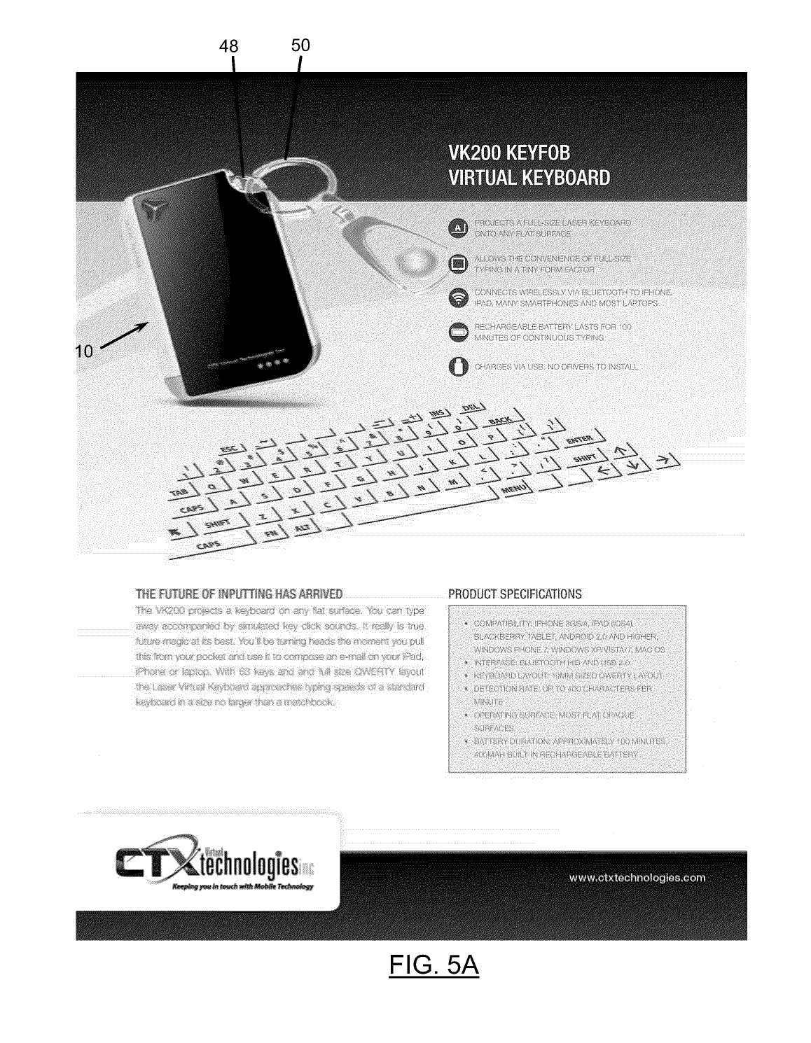

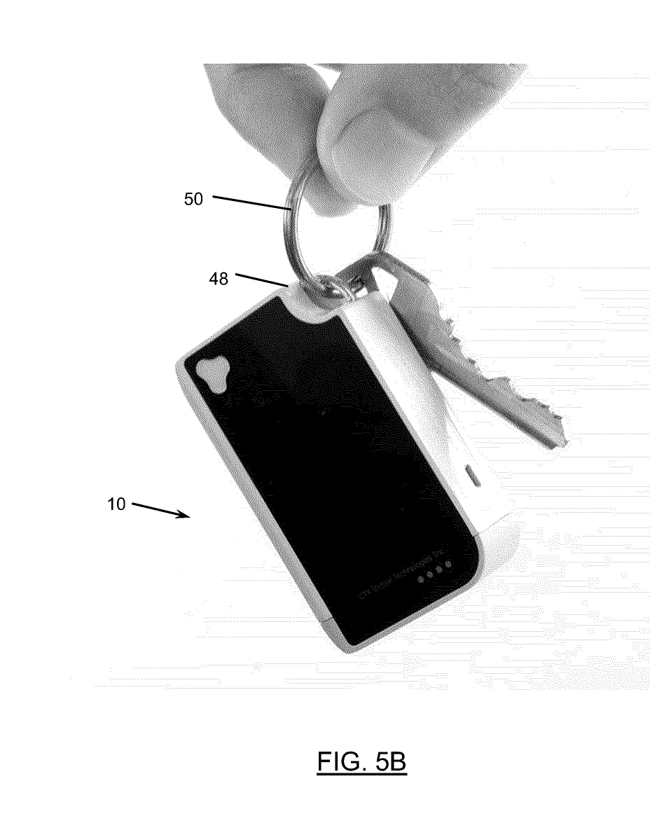

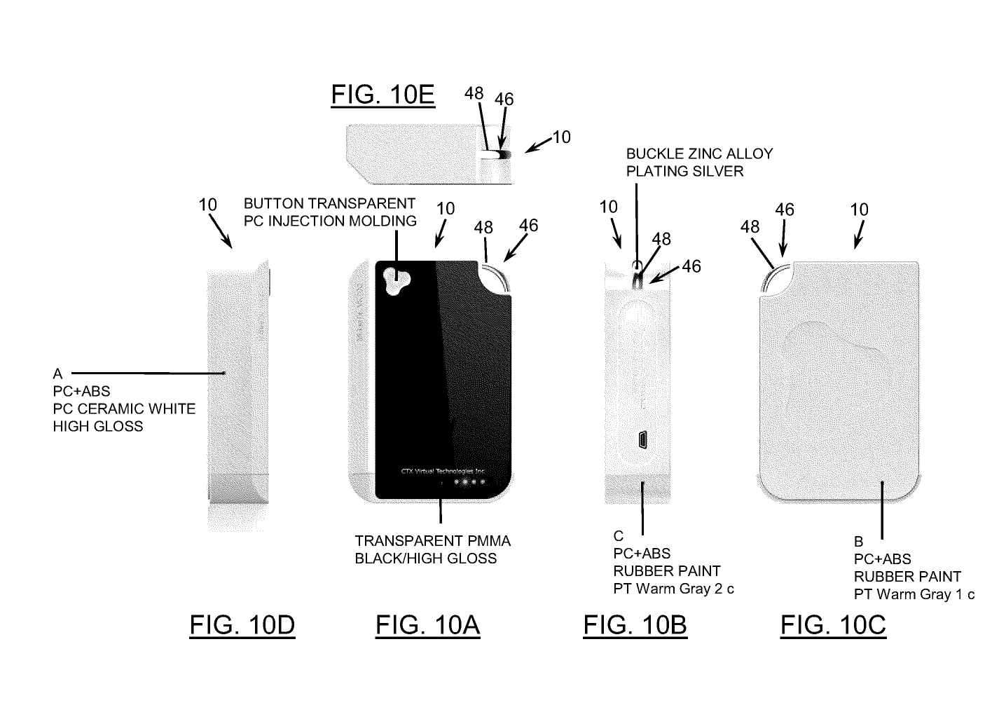

FIGS. 1B, 2 and 3, as well as FIG. 5A, 5B and FIG. 10A to 10E, show the device 10, according to a second embodiment of the present invention, where the communication means 30 is provided a wireless communication module 33, using Bluetooth™, which is embedded in the PCBA 28.

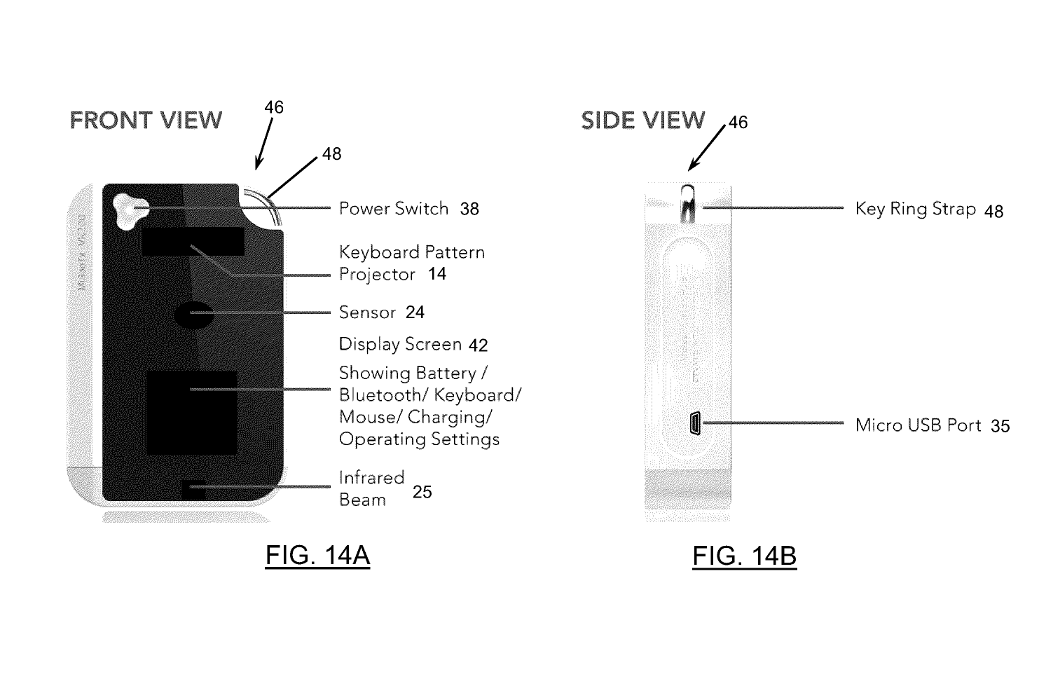

FIG. 14A to 17F show the device 10, according to a third embodiment of the present invention which also comprises communication means 30 provided by a wireless communication module 33, using Bluetooth™, which is embedded in the PCBA 28.

The device 10 further comprises the following components, for all of the first embodiment shown in FIGS. 1A and 4, the second embodiment shown in FIGS. 1B, 2 and 3, as well as the third embodiment shown in FIG. 14A to 17F: an On/Off switch 38, a battery 40, and a user interface 42, including not only the projected keyboard system (keyboard 20 with capture 22 and processing 26), but also an organic light-emitting diode (OLED) display screen 42, and a speaker 44. The device 10 further comprises an attachment component 46, such as ring 48, which allows attaching a key chain 50, as depicted in FIG. 5. Furthermore, the IR module 25 comprises an infrared (IR) light diode and a line generating lens.

It is to be understood that the computing device 34, may be a PDA, tablet computer or the like, or even a larger device such as a laptop computer, conventional desktop computer, etc. as the case may be.

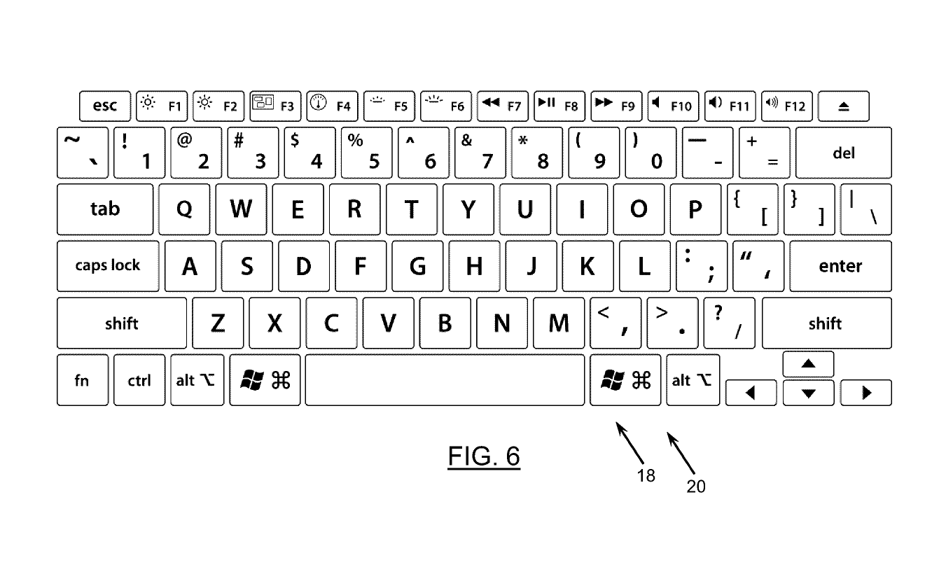

FIG. 6 shows an example of a keyboard 20 being projected by the device 10 in accordance with an embodiment of the present invention.

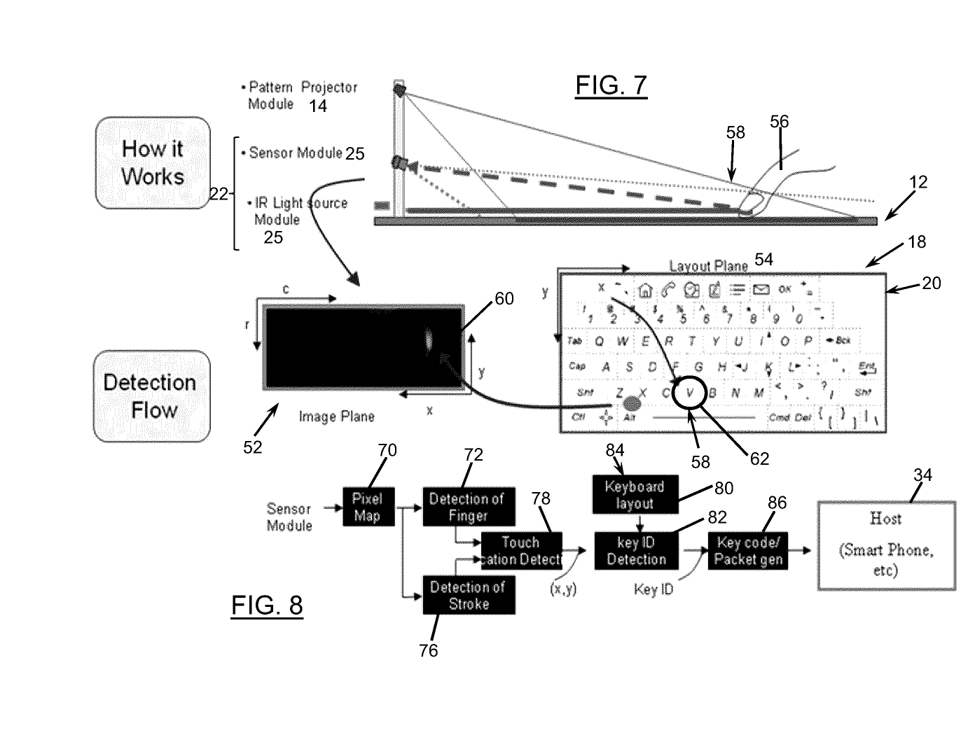

In operation, referring now to FIGS. 7 and 8, the pattern projector module 14, or “laser module” 16 (see FIG. 2), projects the keyboard 20 on the surface 12. The calculator 26 (see FIG. 2) defines an image plane 52 in relation to a layout plane 54 of the projected keyboard 20. The image plane is a pixel map 70. In order to detect a keystroke of an operator 56 of the keyboard 20 (step 72), the sensor module 22 (see FIG. 2) recognizes the signal interruption. The CPU 29 (see FIG. 2) cooperates with the sensor module 22 and the IR light source module 25 in order to determine by triangulation, the location 58 of the keystroke in relation to the layout plane 54. At steps 76 and 78, the CPU 29 further correlates the location 58 on the layout plane 54 with a location 60 on the pixel map 70 (image plane 52). At steps 82, the CPU 29 further correlates the location 58 to a particular key 62 having been operated, by comparing with a keyboard layout 80 stored in the memory 84 (see FIG. 2). At step 86, the CPU 29 further generates a data packet to the computing device 34, being representative of the particular key 62 having been operated by the user 56.

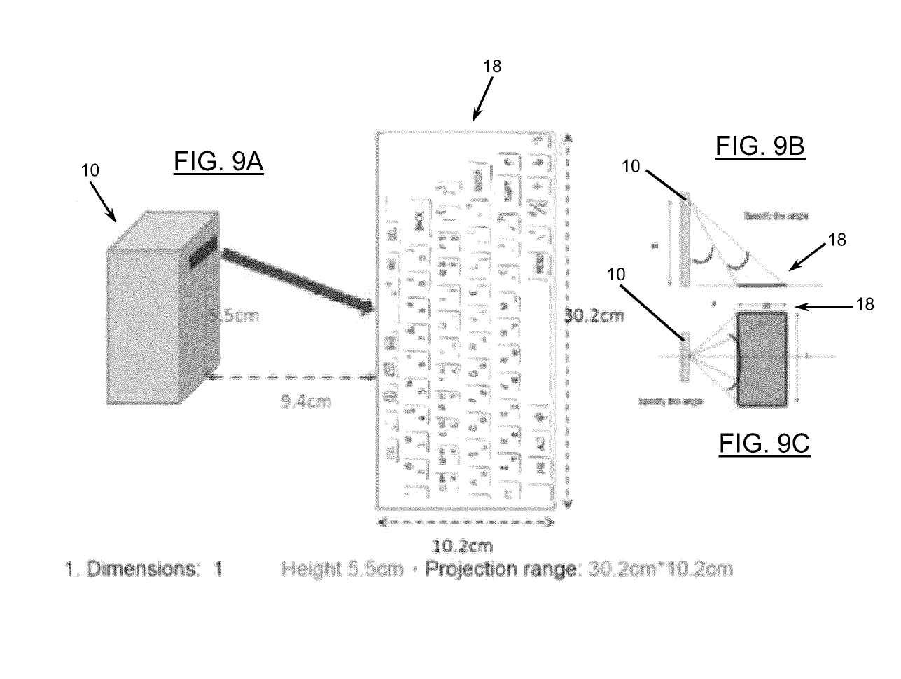

As represented in FIG. 9A to 9C, the camera and lens 24 provides a Field of View (FOV) of greater than 110 degrees enabling the capture of full outer edges of the keyboard template. In the past, engineering challenges of laser projection applications were limited to smaller template work surface, as older virtual keyboard had a narrow band of display and the outer range pictures became blurred due to lack of focus due to the narrow FOV of the collimating lens and diffractive optical elements (DOE). In accordance with the embodiments described herein, the greater field of view provided by the camera and lens 24 allows for clearer outer edge template and recognition of the signal interruption.

Advantageously, the device 10 is a small form factor device, and provides portability. Indeed, the device 10 is compact and small, enabling a user to carry it on a key chain.

Also advantageously, the device 10 connects via Bluetooth™ to handheld PDAs and smartphones via HID (Human Interface Device) or SPP, automatically determining the interface mode without the previously required manual switch for HID or SPP mode. Thus, the user is able to type as fast as with a standard keyboard, so as to enable him/her to input greater amount of data via having access to a full size interactive keyboard.

Functional features of the device 10 according to embodiments of the present invention, include:
Projecting a full-size laser keyboard onto any suitable flat surface.
Allowing the convenience of full-size typing in a small form factor.
Rechargeable battery lasting for 100 minutes of continuous typing.
Charging via universal serial bus (USB) connection, without requiring installation of any driver.
Sound output in order to simulate a key click sound.

Production specifications of the device 10 according to embodiments of the present invention, include:
Compatibility: iPhone™ 3GS/4, iPad (iOS 4), Blackberry™ tablet, Android™ 2.0 and higher, Windows™ Phone 7, Windows™ XP/Vista/7, Mac OS™ □ Interface: Bluetbooth™ HID and USB 2.0.
Keyboard Layout: 19 mm sized, QWERTY layout.
Detection rate: Up to 400 characters per minute.
Operating Surface: Most flat opaque surfaces.
Battery duration: Approximately 120 minute.

### Improved Detection in Bright Light Conditions

In accordance with an embodiment of the present invention, the IR module 25 pulses the infrared beam when an initial picture is taken, and then a second picture is taken without the infrared beam. The CPU 29 then identifies the changes between the two images taken, by subtraction of the second picture from the initial picture. This technique allows for better detection of key press activations and operates in bright light conditions. This contrasts with current systems which use a constant IR emitter and determine the finger position when the tip of the finger has broken the infrared fan beam.

Thus, in accordance with an embodiment of the present invention, with reference to FIGS. 1B and 2, a method for detecting a keystroke operated on an image 18 of a keyboard 20 projected on a surface 12 is provided. The method comprises (a) sensing, by means of a sensing module (such as sensing assembly 22), a keystroke in the projected image 18. The sensing comprises: (i) emitting an IR beam across the projected image by means of an emitter, and capturing a first image of the projected image 18, by means of a sensor (such as camera 24); (ii) capturing a second image of the projected image 18, by means of the sensor (24), while the IR beam is off; and (iii) subtracting, by means of a processor (such as CPU 29), the second image from the first image to detect a difference between the first and second image and to associate said difference with the keystroke. The method further comprises (b) determining, by means of the processor, a location of the keystroke with respect to the projected image 18. The method further comprises (c) associating, by means of the processor, the location with a key of the keyboard 20 based on the layout stored in a memory 84 (see FIG.). The method further comprises (d) generating a command signal corresponding to the key, for transmittal, via an output port (or communication means 30) of the command signal to a computing device 34.

The IR beam pulses on and off, preferably at a frequency ranging from about 30 frames per second (fps) to about 50 fps.

In extremely bright light conditions the infrared beam quickly pulses repeatedly with each on/off frame being added to the previous for multiple frames in order to pick up the very discrete changes that have occurred between the frames where previous methods have failed. Preferably, the IR beam pulses at a frequency ranging from about 35 fps to about 50 fps. Normally a frequency ranging between 35 fps to about 40 fps is suitable.

An issue in current laser keyboards require all components to be firmly mounted and the software to read the keyboard layout that was originally programmed. According to an embodiment, the device 10 provides dynamic calibration of the keyboard, as will be better explained further below, using certain key markers to account for the distortion and rotations.

In accordance with an embodiment, the sensor assembly 22 (see FIG. 2) uses modified dual coding to capture images. Dual coding is a photography technique that enables direct control over which light paths contribute to a photo. More particularly, a lighting sequence or pattern is projected onto a scene. The received signal (the light reflected on an object of interest, i.e. the finger of the user for example, is demodulated in lockstep with the projected sequence. This allows for a direct acquisition of images in which specific light transport paths have been enhanced, specifically the plane of light from the laser diode or “laser module” 16 (see FIG. 2), to the finger(s) of the user and the light is reflected from the finger and captured by the sensor (i.e. camera 24). This dual coding operates almost exclusively in the optical domain and reduces the image processing required to remove ambient lighting and increase the signal to noise ratio. After obtaining the stream of images from the sensor, the images are demodulated to extract the stream of images containing the information of interest.

Thus, the capturing steps (a)(i) and (a)(ii) of the above-mentioned method comprises capturing the first and second images with dual coding, and the sensing step (a) further comprises demodulating the images captured to detect the keystroke In systems which operate in high ambient light conditions the camera/image/sensor is operated with low gains that prevents the acquired signal from saturating. In such conditions the image acquired after demodulation of the dual coding is integrated over several frames to enhance the strength of the required signal.

Thus, the capturing steps (a)(i) and (a)(ii) of the above-mentioned method are operated with a low gain to prevent saturating the captured images.

### Performance Increase

In order to increase performance (reduce computations) and reduce the memory overhead the system down-samples the acquired image(s). Algorithms are implemented to compensate for and reduce the effects of variation in the intensity of the illumination across the span of the keyboard. Thus, the capturing of steps (a)(i) and (b)(ii) of the above-described method comprises compensating for variation in light intensity of illumination across the projected image of the keyboard.

These pre-processed streams of images are then processed to detect the user's fingers. Various advanced image and signal processing techniques are used to detect the user's finger and gestures. In addition to using matched filters based on wavelets and templates on the spatial domain, temporal filters are also used to track individual fingers and detect state changes.

### Multiple Finger Targets

In accordance with an embodiment of the present invention, the device 10 further tracks multiple finger targets and interprets and recognises the gestures made by users based on the relative movement of the fingers target. The system implements temporal filters and smoothing algorithms in order to reduce the jitter and improve the quality of finger tracking and mouse movement. For example, signal processing techniques like moving average filters, polynomial fitting and Bezier curves are used to improve the smoothness of the mouse movement, and interpolation is used to artificially increase the In accordance with an embodiment of the present invention, when the device 10 is in the calibration number of output points. Thus, the mode, the user presses certain keys which are displayed on the screen above-described method comprises detecting a plurality of difference between the first and second images and associating the differences to a plurality of corresponding keystrokes. Furthermore, step (a)(iii) comprises using at least one of matched filters and temporal filters, in order to detect the keystroke on the projected keyboard.

### Calibration

An issue in current laser keyboards require all components to be firmly mounted and the software to read the keyboard layout that was originally programmed.

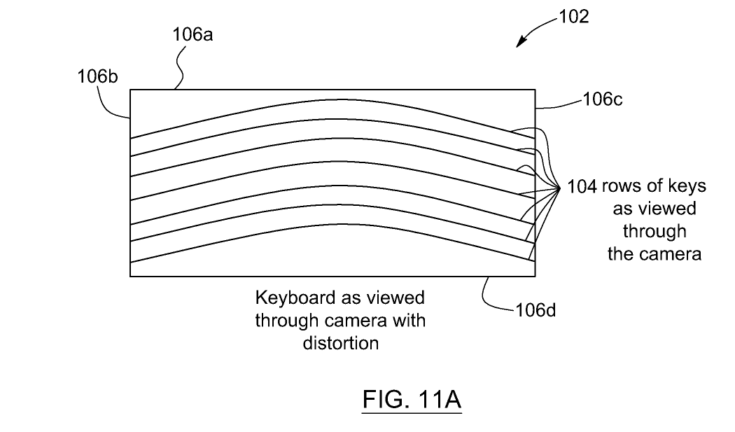

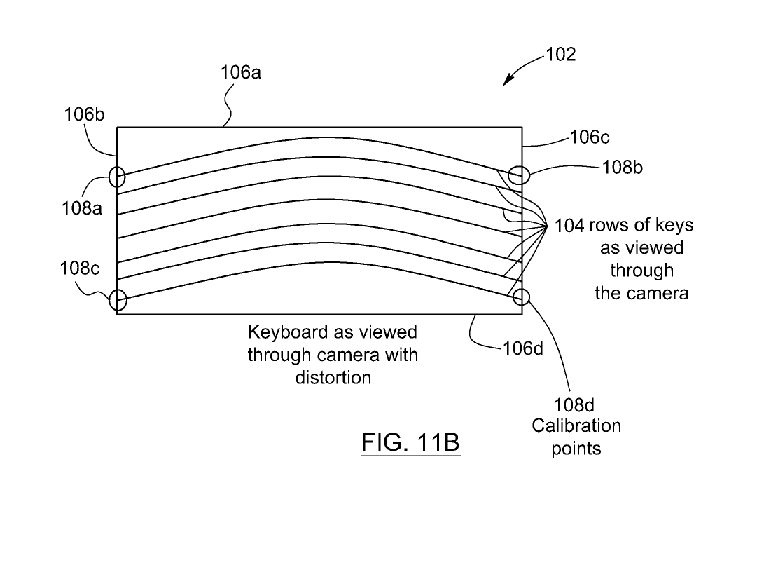

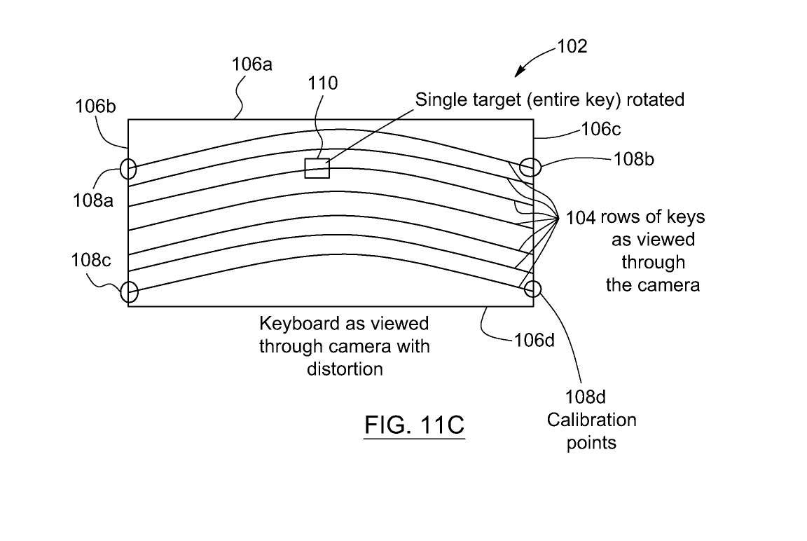

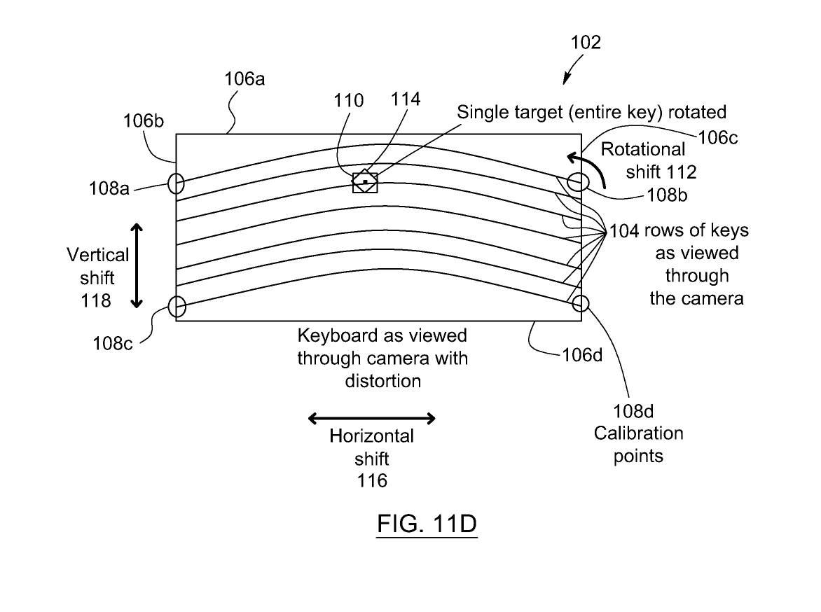

Thus, in accordance with an embodiment of the present, there is provided a calibration method, as better illustrated in FIG. 11A to 11D, for calibrating the device 10 in case of shifting of any component of the device 10 and for correcting initial factory calibration of the device 10.

In accordance with an embodiment of the present invention, when the device 10 is in the calibration mode, the user presses certain keys which are displayed on the screen to guide the user through the calibration process. The memory 84 of the device 10 (see FIG. 2) stores a predetermined keyboard layout in a table format and through the calibration method, prompts the user to touch certain points of the projected keyboard, i.e. the calibration points, of the projected keyboard, in order to recalibrate how the device parses the keystrokes.

The calibration method takes into account distortion caused by the camera's lens due to the high field of view required by the camera. A reference table is provided storing the spacing of the keys to a physical mapping and a correction table is provided for applying correction factors to the physical mapping of the reference table in order to compensate for distortions caused by the camera and the sensing layer directly above the laser keyboard image surface. This table allows correction for the numerous factors previously mentioned.

FIG. 11A to 11D show a graphical outline of the projected keyboard, as viewed by the camera 24. More particularly, when referring to FIG. 11A, the borders 106a, 106b, 106c, 106d represent outer limits of the projection template of the keyboard 20, which are recognized by the camera (or “DOE” or sensor assembly 22). The curved lines 104 inside the borders 106a, 106b, 106c, 106d each represent a row of keys. The calibration method calculates each point on these lines 104 to translate the point into data.

In accordance with an the boundaries and each lines of data points in accordance with the embodiment of the present calibration method, the device recalibrates all of In known projection devices, this parameter may shift, due to distortions appearing on the originally programmed keyboard layout, such that a user's keystroke may be incorrectly translated into the data appearing on the display screen, for example when a user types letter “F”, known projection devices may interpret the keystroke to display the letter “D” on the display screen.

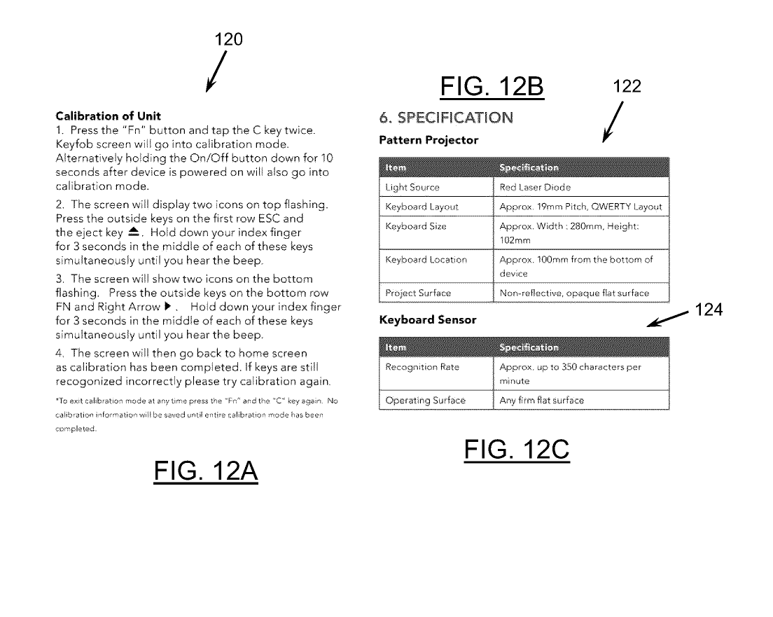

In accordance with an embodiment of the present calibration method, the device recalibrates all of the boundaries and each lines of data points in accordance with the factory setting. More particularly, a user may command the device 10 to enter calibration mode by tapping twice the function key “Fn” and a letter “C” of the projected keyboard, with reference to FIG. 12A.

As illustrated in FIG. 11B, with reference to FIGS. 12A and 17C, once in calibration mode, the device 10, displays a message on the OLED display screen 42 (see FIG. 17C) of the device 10 and/or on the display screen 42 to prompt the user to touch outer upper areas of the keyboard 20, i.e. calibration points 108a, 108b simultaneously for a set period of time (for example between 3 to 10 seconds), namely keys “esc” and “eject” (see FIG. 6). The device 10 captures the location of the points 108a, 108b and emits a beeping sound, via the “speaker” (or “sound/buzzer”) 44 to signal that a measurement has been taken. The user is then prompted via the display screen 42, to simultaneously touch outer bottom areas of the keyboard 20 i.e. “calibration points” 108c, 108d, for a set period of time (for example between 3 to 10 seconds), namely keys “fn” and “arrow right” (see FIG. 6). Based on a capture of the calibration points 108a, 108b, 108c, 108d (or “calibration areas”), the device 10, calculates the location of the borders 106a, 106b, 106c, 106d. Based on the location of the borders 106a, 106b, 106c, 106d, the device 10 resets all of the data points relative to the rows 104 of keys, in order to correlate proper keys 110 to the actual points on the laser template, as better illustrated in FIG. 11C.

Once the calibration is completed, the display screen 42 displays a home display, signalling that the calibration is complete.

The calibration technique being used takes six axis (dimensions) into account, namely a rotational shift 112 as well as horizontal 116 and vertical shifts 118 of the target using the original factory calibration as the reference, as depicted in FIG. 11D. As the image rotates the targets will rotate as well and have lateral displacement. The target 114 may rotate and displace along with image. The center 115 of the target is an original reference point and the target area 114 may be defined as the entire key. This process may extrapolate to the entire keyboard for contiguous mapping by taking into account the calibration points 108a, 108b, 108c, 108d, at the four corners and this can be iterated around the entire keyboard. A rotation of a particular key is detected based on the location of neighboring keys. Shifting and rotation can thus be handled by the above-described calibration technique.

Broadly, there is provided, in accordance with an embodiment, a device for projecting a keyboard on a surface, the device comprising, with reference to FIGS. 1B and 2:
a memory 84 storing the keyboard 20 to be projected;
a light emitter 14 for projecting an image 18 of the keyboard 20 on said surface 12;
a sensor module 22 for sensing an interruption at one or more calibration area of the projected image, the one or more calibration area being associated to one or more predetermined coordinate of the keyboard stored in the memory;
a processor, integrated for example in a CPU 29, which is in communication with the light emitter 14 and the sensor module 22, for determining a location of said interruption with respect to the projected image 18; and—a calculator 26 being integrated in the processor, for calculating the one or more coordinate of the keyboard 20 in the memory 84 based on the location of said one or more corresponding calibration area of the projected keyboard 20.

Thus, the corresponding method of calibrating the projected keyboard 20, comprises the steps of:
projecting, by means of the light emitter 14, an image 18 of a keyboard 20 on a surface 12, the keyboard 20 being stored in the memory 84;
sensing, by means of a sensing module 22, an interruption in the projected image 18 at one or more calibration area (for example calibration points 108a, 108b, 108c, 108d in FIG. 11B) of the projected image 18, being associated to one or more predetermined coordinate of the keyboard 20 stored in the memory 84;
determining, by means of a processor, a location of said interruption with respect to the projected image 18; and—calculating, by means of a calculator, the one or more coordinate of the keyboard 20 in memory 84 based on the location of said one or more corresponding calibration area of the projected keyboard 20.

### Other Features

Referring now to FIG. 12B, the pattern projector module 14 in accordance with an embodiment of the present invention, is configured according to the following specifications:

Light Source: red laser diode;
Keyboard Layout: approximately 19 mm Pitch with a “QWERTY” type Layout; Keyboard Size: approximately 280 mm in width and 102 mm in height;
Keyboard Location: approximately 100 mm from the bottom of the device 10; and Projection Surface: non-reflective, opaque flat surface.

Referring now to FIG. 12C, the keyboard sensor assembly 22, in accordance with an embodiment of the present invention, is configured according to the following specifications:
Recognition rate of up to approximately 350 characters per minute; and
Operating Surface Any firm flat surface.

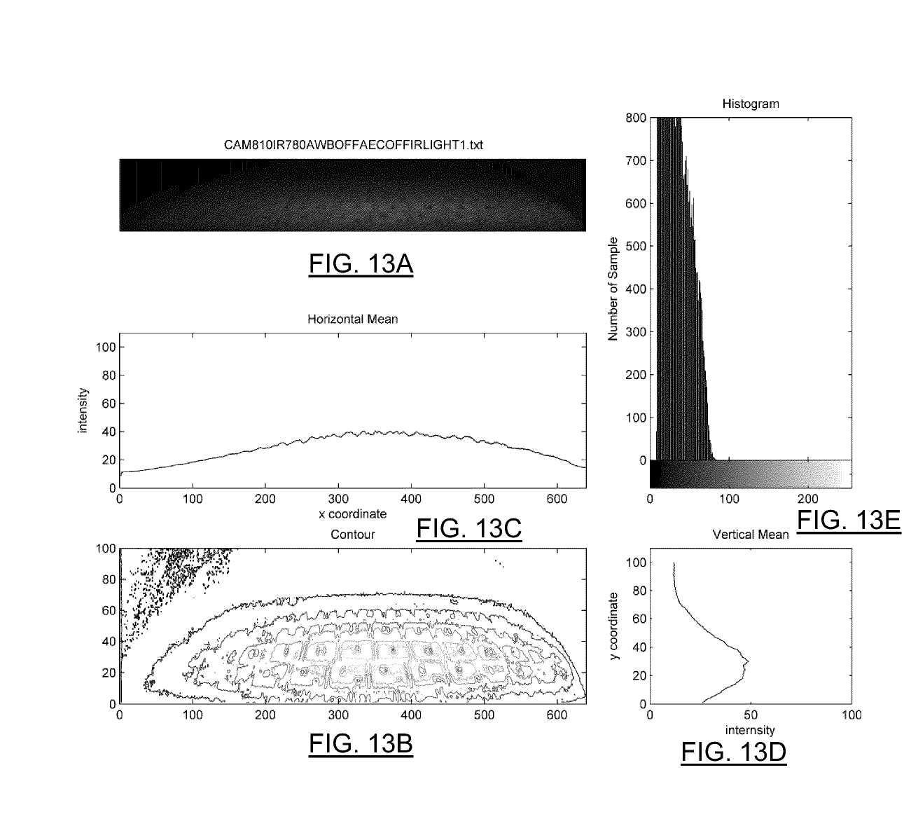

FIG. 13A to 13E are graphs showing an intensity spectrum of the keyboard 20 as sensed by the sensor assembly 22 the device 10, in accordance with an embodiment of the present invention. More particularly, FIG. 13A is a photograph of a keyboard 20 projected by the device 10. FIG. 13B shows an image of the projected keyboard 20 shown in FIG. 13A, as sensed by a sensor 22 of the device 10, the image being referenced horizontally along x coordinates, the image being further referenced vertically along y coordinates. FIG. 13C shows a graph of the intensity of the image of

FIG. 13B, for each x coordinate. FIG. 13D shows a graph of the intensity of the image of FIG. 13B, for each y coordinate. FIG. 13E is a histogram of sample of light intensity of the projected keyboard having been captured by the sensing assembly 22 of the device 10.

As previously mentioned, FIG. 14A to FIG. 17F show the device 10, in accordance with a third embodiment.

More particularly, FIG. 14A shows the device 10 from a front plan view. FIG. 14B shows the device 10 from a side plan view.

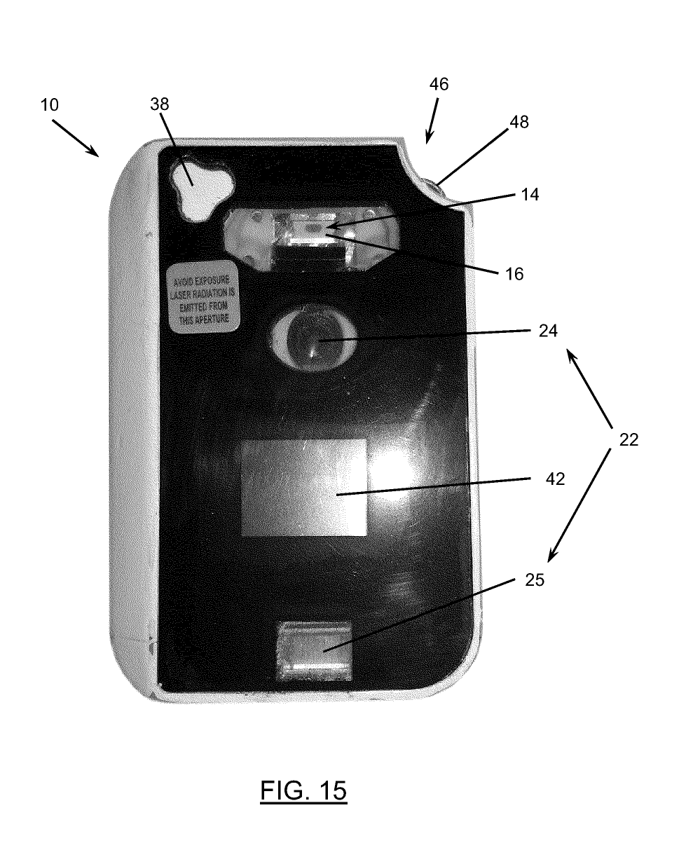

FIG. 15 is a photograph of the device 10 being shown from a front plan view.

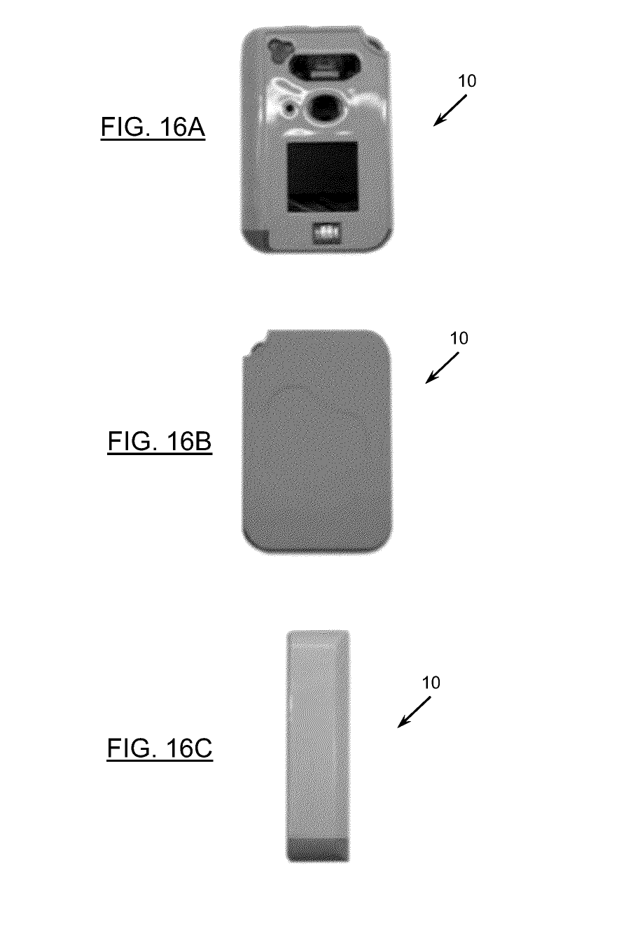

FIGS. 16A, 16B and 16C are also photographs of the device 10 in accordance with the third embodiment, the device being shown from a front plan view, from a rear plan view, and from a side plan view, respectively.

FIG. 17A to 17E are various partial views of the device 10, in accordance with the third embodiment, in order to show inner hardware components of the device 10.

More particularly, FIG. 17A is a front perspective view of the device 10 being shown partially, some components of the device having been omitted. FIG. 17B is another front perspective view of the device shown in FIG. 17A, the device 10 being shown with additional components of the device 10 having been omitted. FIG. 17C is another front perspective view of the device 10 shown in FIG. 17B, the device 10 being shown with additional components of the device having been omitted. FIG. 17D is a side perspective view of the device 10 shown in FIG. 17A, the device 10 being shown with a component drawn in phantom lines. FIG. 17E is a top perspective view of the device shown in FIG. 17C. FIG. 17F is a bottom perspective view of the device shown in FIG. 17C.

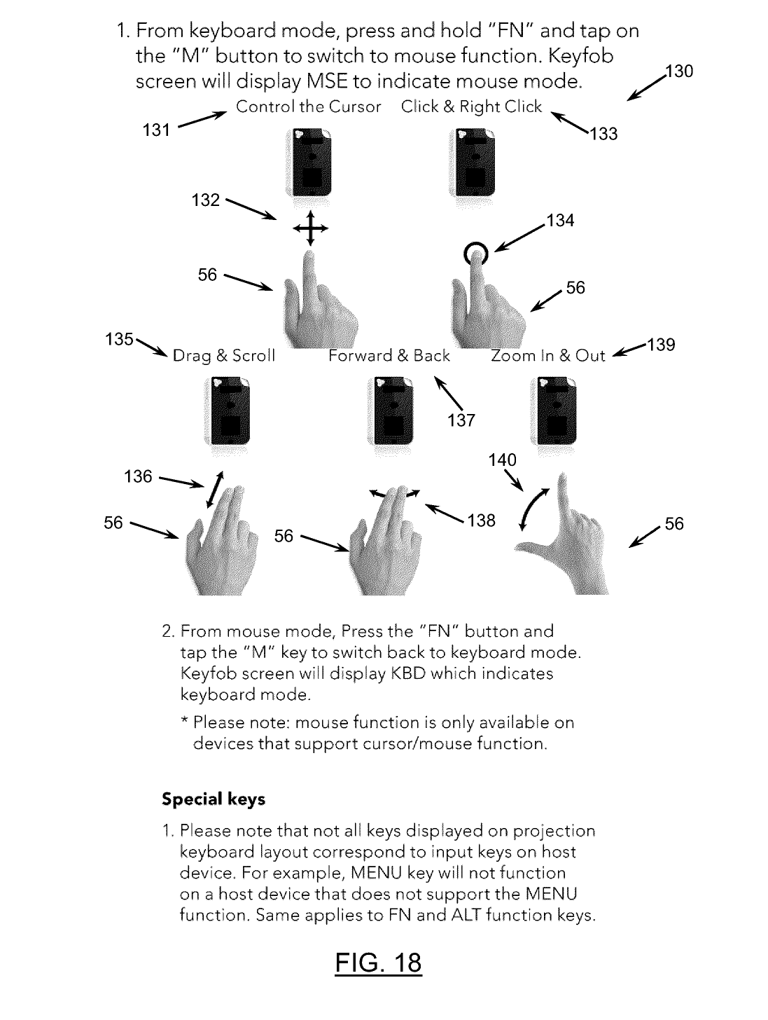

FIG. 18 show steps 130 for operating the device 10, in mouse function, in accordance with an embodiment of the present invention.

From a keyboard mode, the user must press and hold the “FN” key of the keyboard 20 and tap on the “M” key to switch to mouse function. The display screen 42 displays “MSE” to indicate that the projected keyboard 20 is now operational in mouse mode. Various sliding displacements 132, 134, 136, 138, 140 of the user 56 on the projected keyboard 20, with corresponding mouse functions (“control the curser” 132, “click and right click” 134, “drag & scroll” 136, “forward & back” 138, and “zoom in & out” 140) are exemplified in FIG. 18.

Similarly to the keyboard mode, the sensor module 22 (see FIG. 2 or 17C) of the device 10 detects signal interruptions. The CPU 29 (see FIG. 2 or 17C) cooperates with the sensor module 22 and the IR light source module 25 in order to determine by triangulation, the location 58 of the user's finger(s) 56 in relation to the layout plane 54. Thus a sliding movement may be detected by a plurality of measurements taken within a time period. The CPU 29 correlates the detected sliding movement 132, 134, 136, 138, 140 to predetermined control operations 131, 133, 135, 137, 139 stored in the memory 84 (see FIG. 2 or 17C). The CPU 29 further generates a corresponding data packet being representative of the particular mouse control 131, 133, 135, 137, 139 having been operated by the user 56.

Several modifications could be made to the above-described keyboard projection device and system, without departing from the scope of the present invention. Indeed and for example, although the preferred embodiment of the present invention as illustrated in the accompanying drawings uses a laser for projecting the keyboard, it is to be understood that the laser application may be replaced via DLP (Digital Light Processing) technology, for example, whereby instead of single laser beam, the pattern is provided via multiple light beams

It is to be understood, as also apparent to a person skilled in the art, that other suitable components and cooperation therein between, as well as other suitable configurations, organizations and/or architectures may be used for the keyboard projection device and system according to the present invention, as briefly explained herein and as can be easily inferred herefrom, by a person skilled in the art, without departing from the scope of the invention. Moreover, the order of the steps provided herein should not be taken as to limit the scope of the invention, as the sequence of the steps may vary in a number of ways, without affecting the scope or working of the invention, as can also be understood.

Moreover, according to embodiments of the present invention, components or devices additional to those described herein, may be incorporated with the above-described system and/or components thereof, without departing from the scope of the invention, as can be understood by a person skilled in the art.

The above-described embodiments are considered in all respect only as illustrative and not restrictive, and the present application is intended to cover any adaptations or variations thereof, as apparent to a person skilled in the art. Of course, numerous other modifications could be made to the above-described embodiments without departing from the scope of the invention, as apparent to a person skilled in the art.

1. A method for detecting a keystroke operated on an image of a keyboard projected on a surface, to be processed by a computing device, a layout of the keyboard being stored in a memory, the method comprising the steps of:
(a) sensing, by means of a sensing module, a keystroke in the projected image, said sensing comprising:
(i) capturing a first image of the projected image, by means of a sensor;
(ii) capturing a second image of the projected image, by means of the sensor; and
(iii) subtracting, by means of a processor, the second image from the first image to detect a difference between the first and second image and to associate said difference with the keystroke;
(b) determining, by means of the processor, a location of said keystroke with respect to the projected image;
(c) associating, by means of the processor, said location with a key of the keyboard based on the layout stored in the memory; and
(d) generating a command signal corresponding to the key, for transmittal of the command signal to the computing device.

2. The method according to claim 1, wherein the capturing of step (a)(i) further comprises emitting a beam across the projected image by means of an emitter during said capturing of the first image, and switching off said beam for the capturing of step (a)(ii).

3. The method according to claim 2, wherein the beam of step (a)(i) is an infrared beam.

4. The method according to any one of claims 1 to 3, wherein steps (a)(i) and (a)(ii) are performed at a frequency ranging from about 30 frames per second (fps) to about 50 fps.

5. The method according to any one of claims 1 to 4, wherein the sensing further comprises sequentially repeating steps (a)(i), (a)(ii) and (a)(iii) in order to detect discrete changes between the images in bright light conditions.

6. The method according to claim 5, wherein steps (a)(i) and (a)(ii) are performed at a frequency ranging from about 35 fps to about 50 fps.

7. The method according to any one of claims 1 to 6, wherein the capturing of steps (a)(i) and (a)(ii) comprises capturing the first and second images with dual coding, and wherein the sensing step (a) further comprises demodulating the images captured to detect the keystroke.

8. The method according to any one of claims 1 to 7, wherein the capturing of steps (a)(i) and (a)(ii) are operated with a low gain to prevent saturating the captured images.

9. The method according to any one of claims 1 to 8, wherein the capturing of steps (a)(i) and (b)(ii) further comprise compensating for variation in light intensity of illumination across the projected image of the keyboard.

10. The method according to any one of claims 1 to 9, wherein the sensing step (a) further comprises detecting a plurality of difference between the first and second images and associating the differences to a plurality of corresponding keystrokes.

11. The method according to any one of claims 1 to 10, wherein step (a)(iii) comprises using at least one of matched filters and temporal filters, in order to detect the keystroke on the projected keyboard.

12. A keyboard projection device for a computing device, comprising:
a memory for storing a layout of a keyboard;
a projector connected to the memory, for projecting an image of the keyboard on a surface;
a sensing module comprising a sensor for capturing a first image of the projected image and for capturing a second image of the projected image;
a processor connected to the sensing module, for subtracting the second image from the first image to detect a difference between the first and second image to the keystroke, for associating said difference with a keystroke, for determining a location of said keystroke with respect to the projected image, and for associating said location with a key of the keyboard layout stored in the memory; and
an output port connected to the processor for transmitting to the computing device, a command signal corresponding to the associated key.

13. The keyboard projection device according to claim 12, wherein the sensing module further comprises an emitter for emitting a beam across the projected image in order to capture said first image.

14. The keyboard projection device according to claim 13, wherein the emitter is an infrared beam emitter.

15. A storage medium comprising data and instructions for execution by a processor for detecting a keystroke operated on an image of a keyboard projected on a surface from first and second images of the projected image of the keyboard, for the keystroke to be processed by a computing device, said data and instructions comprising:
code means for subtracting the second image from the first image to detect a difference between the first and second image and to associate said difference to the keystroke;
code means for determining a location of said keystroke with respect to the projected image;
code means for associating said location with a key of the keyboard layout stored in the memory; and
code means for generating a command signal corresponding to the key, for transmittal to the computing device.
